(19) United States
(12) Patent Application Publication
(10) Pub. No.: US 2005/0125496 A1
(43) Pub. Date: Jun. 9, 2005

(54) Automatically initiating an instant messaging action when a subscriber's availability status changes

(75) Inventor: Keith A. Thuerk, Southlake, TX (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/726,719

(22) Filed: Dec. 3, 2003

(51) Int. Cl. G06F 15/16

(52) U.S. Cl. 709/204

(57) ABSTRACT

An instant messaging method can include the step of selecting at least one subscriber of an instant messaging service. The subscriber can be in an inactive state in regards to receiving instant messaging communications. At least one action can be designated for an instant messaging client to automatically perform. The subscriber can be monitored for a state change to an active state. The state change can be automatically detected. The designated action can be automatically executed responsive to the detection of the state change.

### BACKGROUND

1. Field of the Invention

The present invention relates to the field of computer software and, more particularly, to instant messaging.

2. Description of the Related Art

Instant messaging (IM) permits text-based messages to be exchanged between users in real time over the Internet or other packet-switched network. Instant messaging requires participating users to register with an IM service and to run a client-side IM application, which will typically execute in the background of a participant's computing device. One advantage instant messaging has over other electronic communication technologies is presence awareness. That is, a user of an IM client can automatically tell when other IM subscribers are available to receive IM communications.

Presence awareness features of an IM client are often implemented by establishing a contact list. The contact list can permit a user to define a set of IM subscribers. Whenever an IM subscriber on the contact list is online and available for IM communications, the subscriber's name, alias, and/or identification can appear within a displayable list, where the list is displayed within a graphical user interface (GUI) window of the client-side IM application.

When a subscriber is unavailable, that subscriber's name will not appear within the contact list GUI window and IM communications cannot be established. It should be noted that a subscriber can be unavailable because the subscriber is not online or because the subscriber has established an IM setting indicating that the subscriber is unavailable. For example, the subscriber can set an “away from computer” or a “do not disturb” setting within an IM application to indicate the subscriber's unavailability status. When an IM user wishes to communicate with an unavailable subscriber, the user must constantly monitor the GUI window to determine when the subscriber becomes available. This constant monitoring can be extremely frustrating to IM users, especially those users needing to contact multiple individuals and those users having long contact lists.

### SUMMARY OF THE INVENTION

The present invention provides a method, a system, and an apparatus for automatically initiating instant messaging sessions. More specifically, a user of an instant messaging (IM) client can indicate within a graphical user interface (GUI) that the user desires an instant messaging session with a subscriber, who is presently unavailable. The subscriber's unavailability status can be due to the IM client of the subscriber being in an inactive state, such as an offline state, a do-not-disturb state, an away-from-desk state, and the like. The user can specify an action to be performed, such as an instant messaging initiation action, as soon as the status of the subscriber changes. The user's IM client can then monitor the subscriber's client for a change of status from an inactive state to an active state. When a change of status is detected, the specified action can be automatically initiated.

One aspect of the present invention can include an instant messaging method. The method can include the step of selecting at least one subscriber of an IM service. The subscriber can be in an inactive state in regards to receiving IM communications. In one embodiment, a group including a multitude of subscribers can be designated and the method can be applied to each subscriber in the group that is in an inactive state. Once an inactive subscriber has been selected, one or more actions can be designated, where each action can be automatically performed when the status of the selected subscriber changes. The designated actions can include an instant messaging initiation action, a notification action, a prompting action, and/or a message conveyance action. The subscriber can be monitored for a state change to an active state. The state change can be automatically detected. The designated action can be automatically executed responsive to the detection of the state change. In a particular embodiment, an inactive state can be designated, so that the designated action can be performed when the subscriber's state changes from the designated state to the active state.

In another embodiment, the selecting of a subscriber, the designating of an action, the monitoring of the subscriber, the detecting of a change in state, and the execution of the action can be performed by the IM client. In a further embodiment, the IM client can be a Lotus Sametime™ type client.

In yet another embodiment, a list of subscribers can be presented within a GUI that includes at least one subscriber that is in an active state and at least one inactive subscriber having a pending IM action that will be executed when the state of the subscriber changes to an active state. The inactive subscriber with a pending IM action can be visually distinguished from the other subscribers in the list. For example, an icon can be associated with the inactive subscriber. Alternatively, the inactive subscriber can be presented in a distinctive font, font color, background color, and the like.

In still another embodiment, a user selectable list of subscribers can be displayed within a GUI, where the subscribers in the list include at least one subscriber in an inactive state. The inactive subscribers can be selected from the list. At least one user selectable option can be displayed within the GUI as a direct result of the selection of the subscriber. A single GUI input can be received. Responsive to this input, an IM action can be designated for the selected subscriber, where the IM action is to be performed when a change in subscriber states occurs. Additionally, the GUI input can result in a monitoring of the selected subscriber for the change in state. When the monitored state change occurs, the designated action can be automatically executed.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a graphical user interface for instant messaging in accordance with the inventive arrangements disclosed herein.

FIG. 2 is a graphical user interface for configuring non-available options in accordance with the inventive arrangements disclosed herein.

FIG. 3 is a flow chart of a method for automatically performing instant messaging actions in accordance with the inventive arrangements disclosed herein.

FIG. 4 is a flow chart of a method for specifying instant messaging actions for currently inactive subscribers in accordance with the inventive arrangements disclosed herein.

### DETAILED DESCRIPTION OF THE INVENTION

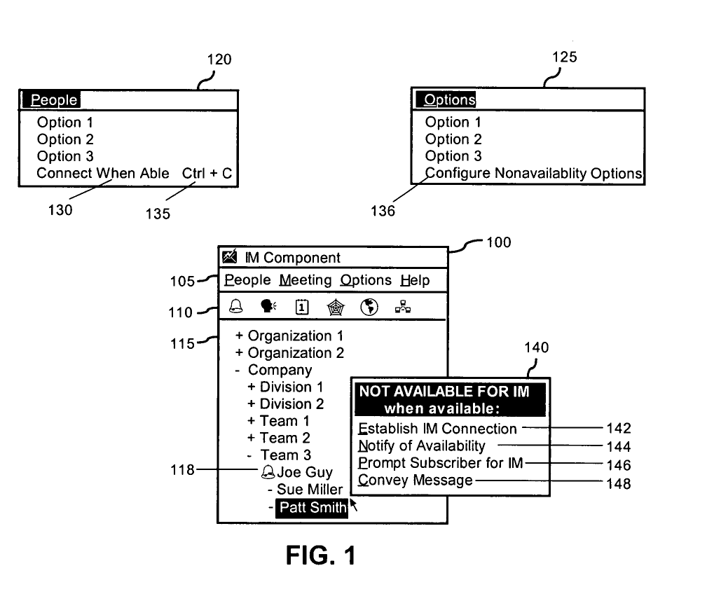

FIG. 1 is a schematic diagram illustrating a graphical user interface (GUI) 100 for instant messaging (IM) in accordance with the inventive arrangements disclosed herein. The GUI 100 can be an interface for any IM client application, which includes stand-alone IM clients as well as an IM client integrated as a component of a communication or collaborative software suite. In one embodiment, for example, the GUI 100 can be an interface for a Lotus Sametime™ type application provided by International Business Machines Corporation (IBM) of Armonk, N.Y.

The GUI 100 can include a contact list section 115, a menu bar 105, and a tool bar 110. The contact list section 115 can display a list of subscribers and groups of subscribers. A subscriber can represent an entity that subscribes to an IM system, where GUI 100 is an interface for an IM client that subscribes to the IM system. The subscribers in the contact list section 115 can further represent a subset of subscribers to the IM system defined specifically for GUI 100. That is, the user of GUI 100 can define those subscribers and groups with whom periodic IM communications are desirable.

User selectable filters and sorting options of the GUI 100 can alter the subscribers displayed within the contact list section 115. For example, a sorting option of GUI 100 can cause all subscribers and groups defined in a contact list to be displayed according to groups, such as Organization 1, Organization 2, Team 1, Team 2, and the like. A different user selectable sorting option can result in an alphabetical listing of all subscribers by last name, user identity, alias, and the like. Additionally, one filter for GUI 100 can cause only those subscribers presently online and/or available for IM communications to be displayed. Similarly, a different filter for GUI 100 can result in the display of those subscribers not capable of receiving IM communications, such as subscribers that are offline, in a do-not-disturb state, in an away-from-desk state, or some other inactive state.

When a subscriber is selected in GUI 100 that is unavailable for IM communications (a subscriber in an inactive state), an option popup 140 can be displayed. For example, the option popup 140 can be automatically displayed when a cursor remains stationary over an inactive subscriber, like Patt Smith, for a previously established time-out period, like five seconds. In another example the option popup 140 can appear as a result of a user input, such as a right-mouse click or “hot key” keyboard combination.

The option popup 140 can provide a multitude of user selectable action to be automatically performed as soon as the selected subscriber becomes available for IM communications. Exemplary actions can include an IM connection action 142, a notification action 144, a prompt subscriber action 146, a convey message action 148, and the like. The IM connection action 142 can automatically initiate an IM session between the user of GUI 100 and the selected subscriber.

The notification action 144 can alert the user of GUI 100 that the selected subscriber has become available. The alerting of the user can occur through any suitable mechanism, such as a popup window appearing in the users screen or a characteristic audio tone/message sounding to alert the user. The prompt subscriber action 146 can be similar to the notification action 144, except the prompt subscriber action 146 can alert the selected subscriber, as opposed to the user, that an IM session with the user is desired.

The convey message action 148 can automatically convey a message to the selected subscriber. In one embodiment, the message conveyed can automatically appear as a first entry of an IM communication session, which can be immediately established between the subscriber and the user of GUI 100. In another embodiment, the message can appear within a popup window on the subscribers computing device.

In one embodiment, a group containing inactive subscribers can be selected within the contact list section 115. In such an embodiment, the option popup 140 can still appear, only now the established actions can be applied to each inactive subscriber within the selected group. For example, if an IM connection 142 is selected for the group of Team 3, an IM session can be automatically initiated with each member of Team 3, as the members become available for communication.

Additionally, a visual identifier 118 can appear within the contact list section 115 for all currently inactive subscribers for whom an IM action has been established. For example, when an option popup 140 is selected for Patt Smith, the visual identifier 118 can appear before Patt Smith in the contact list section 115. The visual identifier 118 can be implemented as any distinguishing GUI property, such as a distinctive icon, a font color, a font, a background color, and the like.

The option popup 140 is one of a variety of designating mechanisms for associating an IM action with a subscriber and the invention is not to be limited in this regard. That is, any of a variety of functionally equivalent designation mechanism can be utilized instead of option popup 140. For example, the toolbar 110 can contain a toolbar button that can be selected to establish an IM action with one or more elected subscribers. In another example, the menu bar 105 can include a menu, such as a menu 120 with a designation mechanism. More specifically, the menu 120 can include an option 130 to establish an IM communication session with the selected subscribers as soon as possible, i.e. when the subscriber becomes available. In yet another example, a hotkey combination, like combination 135, can be used to establish an IM action for a selected subscriber.

The menu bar 105 can also include an options menu 125 for configuring GUI 100. The options menu 125 can, for example, provide an option 136 for configuring non-availability options, such as the options appearing within option popup 140.

It should be noted the mechanisms for selecting subscribers are not limited to those previously described and that any suitable subscriber selection mechanisms can be used. For example, in one embodiment, a user can be prompted to enter a user identity, alias, and/or name for a presently unavailable subscriber; the unavailable subscriber need not appear within the contact list section 115. In another embodiment, a separate popup window (not shown) can be presented that contains a selectable listing of all unavailable subscribers.

It should be appreciated by one of ordinary skill in the art that in order for the functions described for GUI 100 to be performed, some backend processes can be necessary. For example, a background process may be necessary that monitors selected subscribers for a change in state. Such a process can reside within the IM client component of GUI 100, within a server for the IM system, and/or within the IM client of the subscriber. It can be preferable to perform all background processes in the IM client of GUI 100 so that the capabilities described here can be added on a client by client basis regardless to the IM system used. In one embodiment, the IM enhancements for establishing automatic options triggered by subscriber availability can be implemented as plug-in modules configured to enhance existing IM clients.

For example, information regarding the state of subscribers can be tracked by an instant messaging server. This state information can be intermittently conveyed to other subscribers. For example, when a subscriber contained within a client's contact list logs onto the instant messaging server, the instant messaging server can convey a notification concerning the subscriber's availability to the client. Accordingly, the client can monitor for a change in subscriber state by detecting notifications sent by the instant messaging server and responsively performing appropriate actions.

As used herein, a Lotus Sametime™ type application can include any application past and future that is part of the Lotus Sametime™ family of applications as well as compatible and approximately equivalent applications. It should be emphasized that a Lotus Sametime™ type application is just one embodiment of the present invention, which is generally applicable to any IM client and/or GUI interface including IM capabilities.

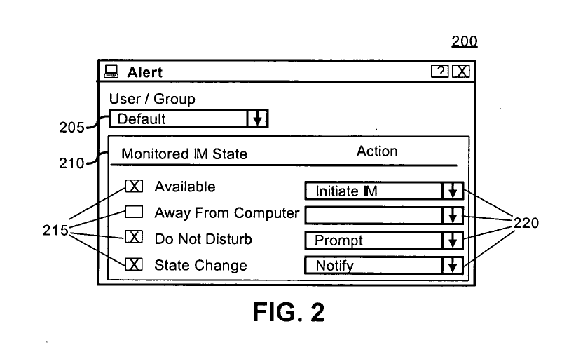

FIG. 2 is a GUI 200 for configuring non-available options in accordance with the inventive arrangements disclosed herein. The GUI 200 can be triggered from a selection within an IM GUI, such as a selection of option 136 in FIG. 1. The GUI 200 can include a selection element 205 and a detail section 210. The selection element 205 can permit the selection of a particular user/group to which the configuration settings of GUI 200 apply. The items contained within the detail section 210 can be automatically adjusted in accordance with the selection in the selection element 205. Setting of the selection element 205 can include a default group setting and a default subscriber setting. The default group settings can apply to all groups that do not have tailored settings associated with them. The default subscriber settings can apply to all subscribers that do not have tailored settings associated with them.

The detail section 210 can include at least one state item 215 and an associated action item 220 for each state item 215. The state item 215 can specify an originating inactive state for a subscriber. Inactive states for state item 215 can include such states as an offline state, an away-from-computer state, a do-not-disturb state, and a state change. A state change can represent a change of the subscriber from one inactive state, such as offline, to a different inactive state.

The action item 220 can specify a client action. When the state item 215 is selected, such as by checking a checkbox, the action item 220 can be enabled. An enabled action can be automatically performed wherever the designated subscriber's state changes from the selected state to an active state. The action item 220 can include actions such as an IM connection action, a notify action, a prompt subscriber action, a convey message action, and the like.

It should be noted that the various GUIs disclosed herein are shown for purposes of illustration only. Accordingly, the present invention is not limited by the particular GUI or data entry mechanisms contained within views of the GUI. Rather, those skilled in the art will recognize that any of a variety of different GUI types and arrangements of data entry, fields, selectors, and controls can be used.

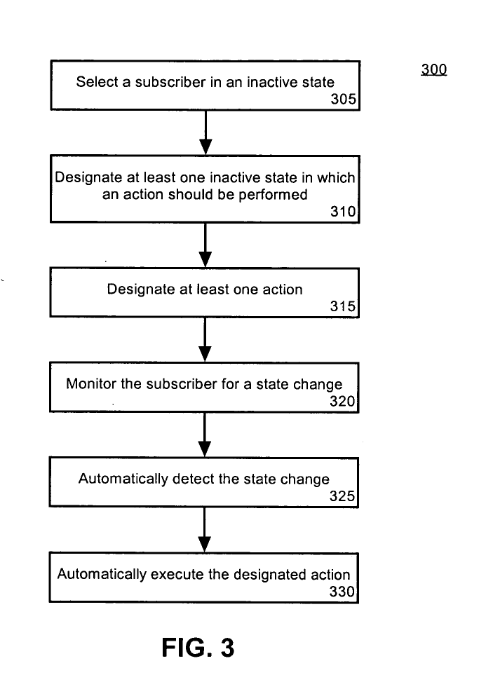

FIG. 3 is a flow chart of a method 300 for automatically performing IM actions in accordance with the inventive arrangements disclosed herein. The method 300 can be performed in the context of an IM client with a graphical user interface. The method can begin in step 305, where a subscriber can be selected that is in an inactive state. An inactive state can be any state where an IM session cannot be established with the subscriber. In step 310, a particular inactive state can be optionally specified. When no option exists for differentially handling particular inactive states, each inactive state can be treated the same. Inactive states can include such states as an offline state, a do-not-disturb state, an out-of-office state, and the like. In step 315, for each previously designated inactive state, at least one action can be designated. If no active state has been previously designated, the designated action can be automatically executed whenever the subscriber's state changes from an inactive state to an active one.

In step 320, the subscriber's state can be monitored for a state change. In step 325, a state change can be automatically detected. In step 330, the appropriate previously designated action can be executed automatically responsive to the detected state change.

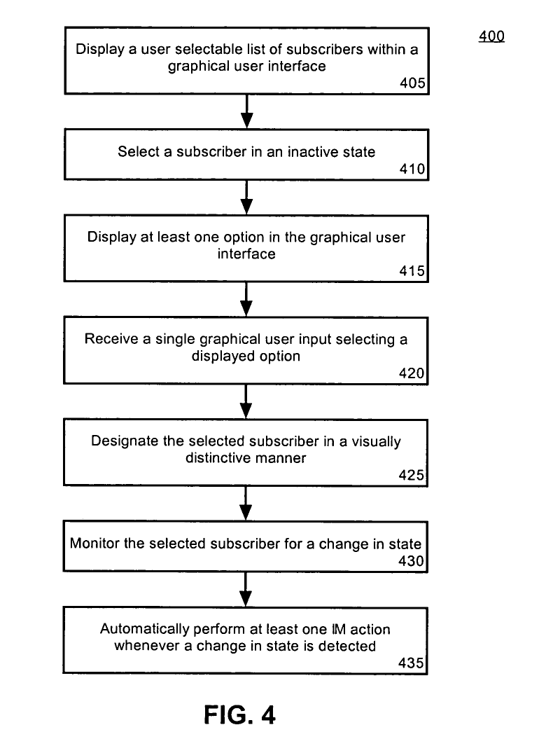

FIG. 4 is a flow chart of a method 400 for specifying IM actions for currently inactive subscribers in accordance with the inventive arrangements disclosed herein. The method 400 can be performed in the context of an IM system, such as the system 100 of FIG. 1. The method can begin in step 405, where a user selectable list of subscribers can be displayed within a GUI. In step 410, a subscriber in an inactive state can be selected from the list. In step 415, at least one option can be displayed in the GUI. The displayed options are optional actions that are to be performed when the subscriber becomes active. For example, a popup list and/or window can be displayed detailing one or more optional actions.

In step 420, a single GUI input can be received that selects a displayed option. The GUI input can include, but is not limited to, a mouse selection, a keyboard input, a touch-screen selection, a joystick selection, and the like. In step 425, the selected subscriber can be designated with the GUI in a visually distinctive manner so that the user can identify those subscribers being monitored for a state change. In step 430, the subscriber can be monitored for a change in state from an inactive state to an active state. In step 435, the designated IM action can be automatically performed whenever a change in the monitored state is detected.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. An instant messaging method comprising the steps of:
selecting at least one subscriber of an instant messaging service, wherein said subscriber is in an inactive state;
designating at least one action for an instant messaging client to automatically perform;
automatically detecting that a state of said subscriber changes to an state change; and
automatically executing said designated action responsive to said detecting step.

2. The method of claim 1, wherein said action is an instant messaging initiation action that initiates an instant messaging session between said client and said subscriber.

3. The method of claim 1, wherein said action includes at least one action selected from the group consisting of a notification action, a prompting action, and a message conveyance action.

4. The method of claim 1, wherein said selecting, said designating, said detecting, and said executing steps are performed by said instant messaging client.

5. The method of claim 4, wherein said instant messaging client includes a Lotus Sametime™ type client.

6. The method of claim 1, wherein said selecting step further comprises the step of:
selecting a group, wherein said group comprises a plurality of subscribers, and wherein said plurality comprises said subscriber of claim 1.

7. The method of claim 6, further comprising the step of:
determining each subscriber in said group that is in an inactive state; and
for each subscriber in said inactive state, performing said designating, detecting, and executing steps.

8. The method of claim 1, further comprising the step of:
designating at least one inactive state associated with said designated action, wherein said state change results from a change from the designated state to said active state.

9. The method of claim 1, further comprising the steps of:
displaying a user selectable list of subscribers within a graphical user interface, wherein said subscribers in said list include at least one subscriber in an inactive state;
selecting said subscriber in an inactive state from said list;
displaying at least one user selectable option within said graphical user interface as a direct result of the selection of said subscriber;
receiving a single graphical user interface input; and
responsive to said single graphical user interface input, performing said designating and said monitoring steps.

10. The method of claim 1, further comprising the step of:
presenting within a graphical user interface a list of subscribers, wherein said list includes at least one subscriber that is in an active state, and wherein said list includes said selected subscriber; and
within said graphical user interface, visually distinguishing said selected subscriber from other subscribers in said list.

11. A machine-readable storage having stored thereon, a computer program having a plurality of code sections, said code sections executable by a machine for causing the machine to perform the steps of:
selecting at least one subscriber of an instant messaging service, wherein said subscriber is in an inactive state;
designating at least one action for an instant messaging client to automatically perform;
automatically detecting that a state of said subscriber changes to an state change; and
automatically executing said designated action responsive to said detecting step.

12. The machine-readable storage of claim 11, wherein said action is an instant messaging initiation action that initiates an instant messaging session between said client and said subscriber.

13. The machine-readable storage of claim 11, wherein said action includes at least one action selected from the group consisting of a notification action, a prompting action, and a message conveyance action.

14. The machine-readable storage of claim 11, wherein said selecting, said designating, said detecting, and said executing steps are performed by said instant messaging client.

15. The machine-readable storage of claim 14, wherein said instant messaging client includes a Lotus Sametime™ type client.

16. The machine-readable storage of claim 11, wherein said selecting step further comprises the step of:
selecting a group, wherein said group comprises a plurality of subscribers, and wherein said plurality comprises said subscriber of claim 11.

17. The machine-readable storage of claim 16, further comprising the step of:
determining each subscriber in said group that is in an inactive state; and
for each subscriber in said inactive state, performing said designating, detecting, and executing steps.

18. The machine-readable storage of claim 11, further comprising the step of:
designating at least one inactive state associated with said designated action, wherein said state change results from a change from the designated state to said active state.

19. The machine-readable storage of claim 11, further comprising the steps of:
displaying a user selectable list of subscribers within a graphical user interface, wherein said subscribers in said list include at least one subscriber in an inactive state;
selecting said subscriber in an inactive state from said list;
displaying at least one user selectable option within said graphical user interface as a direct result of the selection of said subscriber;
receiving a single graphical user interface input; and
responsive to said single graphical user interface input, performing said designating and said monitoring steps.

20. The machine-readable storage of claim 11, further comprising the step of:
presenting within a graphical user interface a list of subscribers, wherein said list includes at least one subscriber that is in an active state, and wherein said list includes said selected subscriber; and
within said graphical user interface, visually distinguishing said selected subscriber from other subscribers in said list.

21. An instant messaging system comprising:
means for selecting at least one subscriber of an instant messaging service, wherein said subscriber is in an inactive state;
means for designating at least one action for an instant messaging client to automatically perform;
means for automatically detecting that a state of said subscriber changes to an state change; and
means for automatically executing said designated action responsive to said detecting step.

22. An instant messaging method comprising the steps of:
determining that a subscriber of an instant messaging system has a status of being unavailable for an instant message communication;
indicating an intension to communicate with the subscriber as soon as the subscriber becomes available;
automatically detecting a status change resulting in said subscriber being available for an instant message communication; and
automatically initiating an instant messaging session that includes said subscriber and said client responsive to said status change.

23. An instant messaging system comprising the steps of:
means for determining that a subscriber of an instant messaging system has a status of being unavailable for an instant message communication;
means for indicating an intension to communicate with the subscriber as soon as the subscriber becomes available;
means for automatically detecting a status change resulting in said subscriber being available for an instant message communication; and
means for automatically initiating an instant messaging session that includes said subscriber and said client responsive to said status change.
